(19) United States
(12) Patent Application Publication
(10) Pub. No.: US 2003/0214458 A1
(43) Pub. Date: Nov. 20, 2003

(54) Multiple display configuration

(76) Inventors: Vladimir Giemborek, Richmond Hill (CA); Syed Hussain, Toronto (CA)

Correspondence Address: VEDDER PRICE KAUFMAN & KAMMHOLZ, 222 N. LASALLE STREET, CHICAGO, IL, 60601, US

(21) Appl. No.: 10/440,674

(22) Filed: May 19, 2003

Related U.S. Application Data
(60) Provisional application No. 60/382,214, filed on May 20, 2002.

(51) Int. Cl. G09G 5/00

(52) U.S. Cl. 345/1.1

(57) ABSTRACT

A system and corresponding method for configuring multiple display systems substantially without user intervention is disclosed. According to the present invention, the method includes the step of determining whether a configuration change has occurred, which corresponds to, for example, a changing of displays coupled to a system or the addition or subtraction of a display, accessing a user display profile, and modifying the user display profile in response to the configuration change based on user preference without user intervention.

### FIELD OF THE INVENTION

The present invention generally relates to computing systems and, more particularly, to a system and method capable of configuring multiple displays.

### BACKGROUND OF THE INVENTION

Computers are known to comprise a central processing unit, system memory, audio processing circuitry, peripheral ports and video processing circuitry. The peripheral ports allow the central processing unit to communicate with peripheral devices such as monitors, printers, external tape drives, etc. Video graphics circuitry may function as a coprocessor to the central processing unit to perform video graphics functions. As such, the video graphics circuitry receives graphical data generated by the central processing unit and renders the graphics data into pixel data that is subsequently displayed on a corresponding monitor or display device. The data that the video graphics circuitry converts to pixel data and displays on a monitor is stored in a frame buffer.

As is known, a computer system may include a plurality of video graphics cards or suitable controllers that are operable to support an individual monitor or display. Each individual display has a specific given set of display settings, such as, for example, color depth, refresh rate, etc. The display settings are provided to the central processing unit during, for example, start-up of the computer system. Additionally, display settings may be provided to the central processing unit by the user as a result of a hot-button or control panel swapping of displays.

Display parameters, such as desktop size, color depth and refresh rate are based solely on the display capabilities of individual displays. Thus, when a new display is connected to the system, the color depth and display refresh rate must be adjusted to correspond to the different and/or newly added display. Conventionally, such adjustments are provided by the user manually entering the information every time a new display is added to or removed from the system. This is disadvantageous in that it first requires the user to always be at the computer system when a display is added or subtracted. Second, it precludes hot swapping of displays as the new display parameter data is not automatically accessible to the underlying system. Third, errors are increased due to the user incorrectly entering the new display information.

In addition, to avoid changing display settings when moving between different configurations, user settings need to be saved on a per display configuration basis and restored when the same display configuration is detected. This is resource and time inefficient due to the large amount of memory that has to be accessed and the amount of time required to access and transfer such data.

Thus, there is a need for the ability to automatically adjust display settings with minimal or no user intervention when display configuration changes occur.

### BRIEF DESCRIPTION OF THE DRAWINGS

The present invention and the advantages and features provided thereby, will be best understood upon review of the following detailed description of the invention, taken in conjunction with the following drawings, where like numerals represent like elements, in which:

FIG. 1 is a schematic block diagram of a computer system incorporating the configuration system according to the present invention;

FIG. 2 is a flow chart illustrating the operating steps performed by the computer system illustrated in FIG. 1 when configuring a display system of a configuration change occurs; and

FIG. 3 is a flow chart illustrating the operating steps performed when a new device is added to the computer system according to the present invention.

### DETAILED DESCRIPTION OF THE INVENTION

Briefly stated, the present is directed to a system and corresponding method for configuring a system to display visual or graphical data on any display or combination of displays without user intervention. The configuration method of the present invention is more flexible than conventional configuration methods which are limited in the number of configurations that may be supported and, additionally, requires user intervention. In an exemplary embodiment, the configuration method of the present invention comprises accessing a user display profile; determining whether a configuration change has occurred; and modifying the user display profile in response to the configuration change based on user preference without user intervention. Modifying the display profile further comprises receiving the display characteristics of the new display or displays in response to the configuration change and adding or substituting the new display characteristics to the display profile. The displays are then automatically adjusted to present succeeding visual and/or graphical data with the modified display characteristics.

The user display profile is comprised of a searchable database that is indexed by the display characteristics of the plurality of displays that have previously been coupled to the underlying system or provided by the user during an initial session. The display characteristics that form the display profile include, for example, maximum resolution, color depth, desktop size, refresh rate, etc. The system may include a processor that is capable of receiving the display characteristics from the displays coupled thereto and automatically search the display profile after a configuration change occurs in order to modify, or otherwise update the same without user intervention.

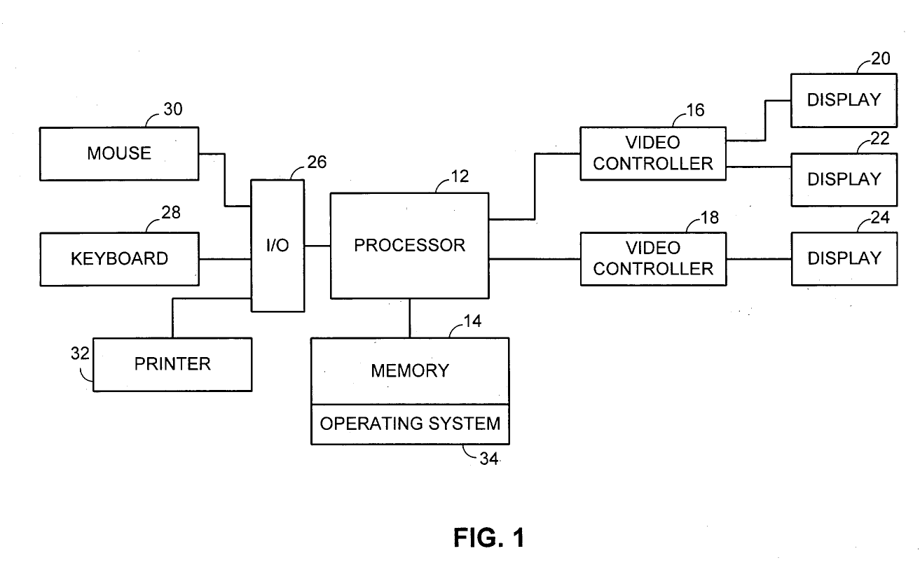

An exemplary embodiment of the present invention will now be described with reference to FIGS. 1-3. Referring now to FIG. 1, illustrated therein is a schematic block diagram of a computing system 10, incorporating the configuration system according to the present invention. Such a computing system 10 may be a personal computer, laptop computer, video game system, personal digital assistant (PDA), palm top computer, hand-held computer and/or any device that performs and executes programs and/or algorithms. The computing system 10 includes a processor 12, a memory 14, including an operating system algorithm 34, a first video controller (e.g. video graphics card) 16, a second video controller (e.g. video graphics card) 18, a plurality of displays 20-24, an input/output (I/O) module 26 and a plurality of input devices 28-32, coupled to the I/O module 26, operative to provide input or data to the processor 12 (e.g. keyboard 28, mouse 30) or receive output data from the processor 12 (e.g. printer 32). As one of ordinary skill in the art will appreciate, the processor 12 may be a microprocessor, microcomputer, digital signal processor, state machine, logic circuitry and/or any device that manipulates signals (analog or digital) based on operational instructions.

As illustrated, the first video controller 16 is adapted to control the presentation of visual and graphical information on display 20 and display 22. The second video controller 18 is adapted to control the presentation of visual and graphical information on display 24. Although, illustrated as including two video controllers, it will be appreciated by one or ordinary skill in the art that the system 10 may include a single video controller that supports multiple displays and/or multiple video controllers that each support a single or multiple displays. The displays 20-24 may be an LCD display, a CRT display, flat panel display, a touch screen or any suitable device or combination of devices capable of presenting graphical or other visual information. In operation, the video controllers can be video graphics cards capable of providing visual (e.g. pixel) information to a corresponding display, based on data provided by the processor 12.

The memory 14 may be either a random access memory (RAM), read only memory (ROM), floppy disk, hard drive, flash memory or any suitable type of device, structure or storage medium capable of storing programs, algorithms and/or digital information. Note that if the processor 12 implements one or more of its functions via a state machine or logic circuitry, the memory storing the corresponding operational instructions would be embedded into the circuitry comprising the state machine or logic circuitry.

In an exemplary embodiment, the memory 14 is used to store a user display profile during operating periods of the processor 12, when configuring the system 10 to handle multiple displays and/or multiple combination of displays without user intervention. In application, the user display profile is comprised of a database of values including, but not limited to, the following parameters or settings: device (or display) identification (e.g. LCD, CRT); maximum display resolution (e.g. 1024×760(LCD) or 1600×1200(CRT)); and maximum refresh rate (e.g. 60 Hz or 85 Hz); desktop size; color depth; and display to CRT controller mapping for all active displays. A key is associated with and identifies the aforementioned parameters within the display profile. An operating system 34, which includes instructions that the processor 12 executes at startup and during system resumption periods is also maintained within the memory.

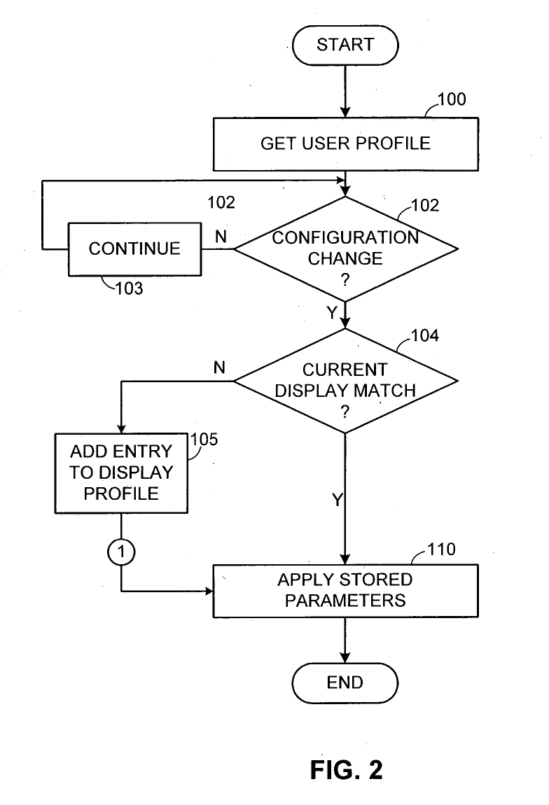

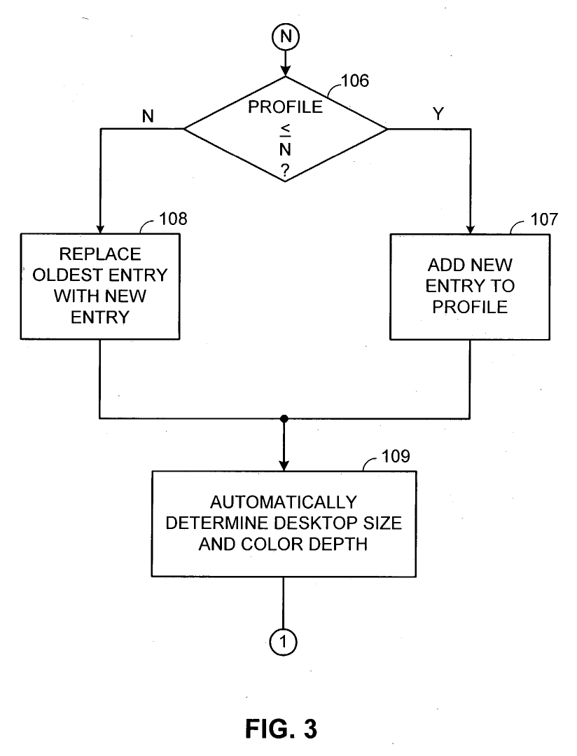

The operating system 34 functions to start up the computing system 10 and to maintain its operation. As part of the start-up procedure, the operating system 34 provides inquiries to the video controllers 16, 18 to obtain the display characteristics of the primary display coupled thereto. This information is provided to a user level program that is executable by the processor 12, and causes the processor to perform the steps described below with reference to FIGS. 2 and 3. In accordance with the present invention, the video controllers 16, 18 will provide, during some portion of the execution of the operating system start-up, the display characteristics. When a configuration change, for example, adding another display or combination of displays to the system 10 occurs, the operating system queries the corresponding video controllers to provide the display characteristics of the new displays to the processor 12 for updating the display profile, if necessary, and to automatically adjust the display settings to accommodate the new displays and to ensure that the graphical and visual information is properly displayed.

The configuration changes that promote automatic display parameter adjustment are the following: bootup or start-up of the system 10; resumption of operation (e.g. resume from hibernation or other corresponding low or reduced power mode); docking/undocking; lid close/open; display hot plug/unplug; and display device selection change by the user through, for example, hot key or control panel. The steps performed by the processor 12 when adjusting the display profile and display settings of the system 10 will now be described with reference to FIGS. 2 and 3.

Referring to FIG. 2, the process begins at step 100 where the user display profile is accessed. The initial or original user display profile is established by the user and is maintained in the registry so that the same is available during system start-up. Any adjustments or modifications made to the user display profile, for example, upon completion of the configuration algorithm of the present invention are maintained in the registry for subsequent use. The process then proceeds to step 102.

In step 102, a determination is made as to whether a configuration change has occurred. As part of this step, the type and capabilities (e.g. maximum resolution) of the at least one display coupled to the system are retrieved. Examples of a configuration change include, for example, the addition or subtraction of a new display, or the resumption of display operation from a hibernation period, or the docking/undocking of the system. If no configuration change is detected, the process continues operating in the current state (step 103) with the current parameters. On the other hand, if a configuration change has been detected, the process proceeds to step 104.

In step 104, a determination is made as to whether the new display matches an entry in the current user display profile. If a match is present, the process continues to step 110 where the display settings are substituted to accommodate the new display or plurality of displays. Otherwise, the process continues to step 105, which is discussed in greater detail with reference to FIG. 3.

In step 105, the display characteristics or parameters of the new display are added to the user display profile. If new display parameters are to be added to the user profile, first a determination is made in step 106 if the contents of the display profile exceed a threshold value, N. If the threshold value has not been exceeded, the new display parameter is added to the user display profile in step 107. Otherwise, the process proceeds to step 108 where the new entry replaces the oldest entry within the user display profile. After completing steps 107 or 108, the process continues to step 109.

In step 109, the desktop size and color depth to be supported are automatically determined by a modified best view algorithm. The modified vest view algorithm first attempts to lower the color depth (e.g. 32 bbp to 16 bbp only) before decreasing view size. When a view size is determined, the desktop size would be set to equal the view size with certain exceptions (e.g. maintaining the new desktop size equal to or greater than 800×600). The process then continues to step 110.

Returning back to FIG. 2, after the user display profile has been modified, the new desktop and view size, along with the other appropriate display settings are applied to accommodate the new display(s) in step 110. The above described method is performed every time the processor is alerted of a configuration change. Such alert can be received from a miniport of the system, an operating system message or during an application load (e.g. bootup).

As illustrated, the above method is performed without user intervention. Thus, no user action is required to modify to computing system to accommodate a new display or plurality of displays as compared to prior art methods. This provides for increased efficiency of system configuration and use of system resources. Also, flexibility in modifying a display system is accomplished as the system is not restricted to only a specific set of displays or devices and does not require the system to reset to default values upon power down as is required in conventional systems.

The above detailed description of the invention and the examples described therein have been provided for the purposes of Illustration and description. Although an exemplary embodiment of the present invention has been described in detail herein with reference to the accompanying drawings, it is to be understood that the present invention is not limited to the precise embodiment(s) disclosed, and that various changes and modifications to the invention are possible in light of the above teaching. Accordingly, the scope of the present invention is to be defined by the claims appended hereto.

What is claimed is:

1. A method for configuring multiple displays, comprising:
determining whether a configuration change has occurred; and
accessing a display profile in response to the changed configuration based on user preference.

2. The method of claim 1, further including the step of modifying the display profile in response to the changed configuration.

2. The method of claim 1, wherein the display profile is generated without user intervention.

3. The method of claim 1, wherein the user preference is a searchable profile generated at start up.

4. The method of claim 1, wherein the configuration change comprises one of the following: resume from hibernation, docking/undocking, display hot plug/unplug, user initiated display change.

5. A method for configuring displays, comprising the steps of:
accessing a user display profile;
determining whether a configuration change has occurred; and
modifying the user display profile in response to the configuration change based on user preference without user intervention.

6. The method of claim 5, wherein the step of modifying the user display profile further includes the steps of: receiving display characteristics of a new display in response to the configuration change and adding the display characteristics to the user display profile.

7. The method of claim 5, further including providing information to displays based on the modified user display profile.

8. The method of claim 5, wherein the user display profile is generated at start up.

9. A multiple display system, comprising:
a processor;
at least one display coupled to the processor; and
a memory coupled to the processor, wherein the memory includes operational instructions that when executed cause the processor to: (a) access a user display profile; (b) determine whether a configuration change has occurred; and (c) modify the user display profile in response to the configuration change without user intervention.

10. The system of claim 9, further including video controller coupled to the at least one display, operative to control the presentation of data on the display.

11. The system of claim 9, wherein the memory further includes operating instructions that when executed cause the processor to receive the display characteristics of the at least one display.

12. The system of claim 9, wherein the memory further includes operating instructions that when executed cause the processor to receive the display parameters of a new display when a configuration change has occurred.

13. The system of claim 12, wherein the memory further includes operating instructions that when executed cause the processor to update the user display profile with the display parameters of the new display.

14. The system of claim 13, wherein the memory further includes operating instructions that when executed cause the processor to determine whether the user display profile exceeds a predetermined value and replacing the oldest entry in the user display profile with the display parameters of the new display.
